(19) United States
(12) Patent Application Publication
(10) Pub. No.: US 2005/0237403 A1
(43) Pub. Date: Oct. 27, 2005

(54) SYNCHRONIZING OF TIME DISPLAY AND INTEGRATION CAMERAS

(76) Inventors: Ibrahim Cem BAYKAL, Calgary, Alberta (CA); Graham A. JULLIEN, Calgary, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/907,928

(22) Filed: Apr. 21, 2005

Related U.S. Application Data
(60) Provisional application No. 60/521,414, filed on Apr. 21, 2004.

(51) Int. Cl. H04N 5/335

(52) U.S. Cl. 348/295

(57) ABSTRACT

A method and system for synchronizing time delay and integration cameras by measuring high frequency components of the TDI camera output and varying either charge velocity within the camera or image velocity, in order to maintain the maximum point of the high frequency components.

### FIELD OF INVENTION

The present invention relates to a method and apparatus for synchronizing time delay and integration cameras.

### BACKGROUND OF THE INVENTION

Image sensors convert light intensity to voltage or current and are widely implemented in video cameras and digital cameras. The development of solid state image sensors has made modern machine vision a viable process for the monitoring and control of industrial processes. Industrial line-scan cameras are usually either complementary metal-oxide semiconductor (CMOS) or charge-coupled device (CCD) designs. Both CMOS and CCD imagers are constructed from silicon, which gives them fundamentally similar properties of sensitivity over the visible and near infrared spectrum. Both types of imagers convert light into electric charge and process it into electronic signals. In a CCD sensor, the electrons are stored in potential wells that are formed under sets of electrodes. The stored charge in each well may be serially transferred through adjacent wells by applying special multi-phase clock pulses to the electrodes. There can be several serial charge transmissions to output nodes in a large sensor, but these are typically limited in number, and often limited to one. The output nodes convert the serially transmitted charge to voltage, where it is buffered, and sent off-chip as an analog signal. All of the pixel surface area can be devoted to light capture, and the output's uniformity is high, which contributes to high image quality.

In a CMOS sensor, each pixel has its own charge-to-voltage conversion, and the sensor often also includes digitization circuits, so that the chip outputs digital data. These other functions reduce the area available for light capture, and with each pixel providing its own conversion, uniformity is lower, but the chip requires less off-chip circuitry for basic operation.

CCDs became the dominant solid-state imager, primarily because they provided superior images within the limitation of the then-available fabrication technology. CMOS image sensors could not, until recently, deliver the desired uniformity and small feature sizes. Semiconductor fabrication has now advanced to the point where CMOS image sensors can be useful and cost-effective in some midperformance imaging applications. CCDs still offer superior image performance, measured in quantum efficiency and noise, and flexibility at the expense of system size. They continue to dominate in the applications that demand the highest image quality, such as most industrial, scientific, and medical applications. CMOS imagers offer more integration (more functions on the chip), lower power dissipation (at the chip level), and smaller system size at the expense of image quality and flexibility. They are well-suited to high-volume, space-constrained applications where image quality is not paramount, such as security cameras, PC peripherals, toys, fax machines, and some automotive applications. It is clear that CMOS technology is steadily improving and more of the traditional CCD markets are starting to be taken over by CMOS imagers.

Time-delay and integration (TDI) technology is a well-known method to exploit a CCD device's charge accumulation property by combining it with the well known image overlapping technique that is used to reduce noise in digital pictures. In an array of sensors, due to imperfection of fabrication, each sensor element has a different sensitivity. The end product of this nonuniform sensitivity is noise in the resultant digital image. One method to reduce this noise is to take pictures of the same scene by using different sensors and than superimpose all of the digital images taken by these sensors. Because the statistical sensitivity variance of a sensor element corresponding to picture pixel is different in every sensor, superimposing the digital pictures will cancel out this effective noise.

In a line-scan camera this can be done in a more practical way. A line-scan sensor consists of one dimensional sensor elements unlike an area-scan sensor that has a two dimensional matrix of sensor elements. The object and the line-scan sensor should move relative to each other, or in other words the sensor should scan the object to obtain the full body picture of that object. If two line-scan sensors next to each other and these two sensors scan the object at the same time as shown in FIG. 1, then we would have two digital pictures of the same object taken with different sensors. However these two digital pictures would be slightly different from each other because of the physical location difference of the sensors. These images would be shifted versions of each other.

TDI technology compensates for the displacement difference between the two digital pictures obtained from these sensors and superimposes the images. In a TDI sensor, there are a plurality of rows of CCD sensors, usually up to 96. When the first row scans the object, the CCD elements in that row accumulate charge proportional to the intensity of the image at the pixel positions in the first row. When the object moves and the part of the object which the first CCD row scanned is under the second row of CCDs, the charge accumulated in the first row is transferred to the second row. The second row accumulates more charge over this transferred charge as a result of it s own scanning process. Since the charge accumulated in the second sensor is the sum of the resultant charges due the scanning processes of both sensors, this operation practically superimposes two images obtained by these two sensors. Therefore, repeating this process using 96 different sensors is equivalent to taking 96 snapshots of the same picture and superimposing them to obtain a composite image. Accordingly, every sensor scans shifted versions or delayed versions of the same image and then the result is integrated.

The increased quality of the images obtained with a TDI sensor may only be obtained if the charge movement between the adjacent CCD cells is synchronized with the speed of the product that moves under the camera. Failing to do so results in motion blurred images. The conventional approach in industrial applications is to use a shaft encoder to measure the speed of a conveyor belt and generate clock signals using the shaft encoder to synchronize the charge movement. The major disadvantage of this approach is the need to use external circuitry and the lack of freedom to change the zooming magnification of the camera lens system. When the image is zoomed, the trajectory of the object on the sensor moves faster making it compulsory to increase the clock pulse per revolution output of the shaft encoder. Since that value is fixed for the shaft encoders, changing the zooming also requires changing the shaft encoder. In other TDI applications, equivalent independent techniques are used to provide image velocity information. An alternative example is the use of TDI sensors in aerial photography, where the velocity of the aircraft is independently measured and used to control the TDI sensor charge movement.

It would be advantageous if the image velocity could be measured using the image sensors. Therefore, there is a need in the art for methods and systems for synchronizing charge movement across an image sensor with the actual velocity of the object being imaged.

### SUMMARY OF THE INVENTION

The present invention incorporates novel methods to indirectly measure the image velocity within the TDI sensor itself. Such methods may involve the use of the output of the TDI sensor directly where synchronization is inferred based on the output of the TDI sensor itself. This technique may be implemented where information can be obtained from the output that provides a measure of synchronization. Therefore, this technique comprises the use of a type of extremal algorithm to maintain synchronization. Because the output image of the TDI sensor experiences motion blur (reduction of spatial bandwidth) when the charge speed and image speed are not matched; a synchronization algorithm may be implemented by performing an extremal search for the maximum spatial bandwidth of the output of the TDI sensor.

The difference between the charge movement and the image movement speed causes distortion in the output image of a TDI line scan camera. This distortion is due to the low-pass filtering effect of the TDI process when it is not ynchronized. The algorithms of the present invention generally synchronize the charge movement speed by detecting the change in the frequency components of the output image and take countermeasure by changing the speed of the TDI charge movement until the distortions are removed. Therefore, the algorithm is one that tracks the speed of the image movement, based on the distortion of the frequency components of the camera output image.

Therefore, in one aspect, the invention may comprise a method of synchronizing a time delay and integration (TDI) camera having a TDI output with high frequency components, comprising the step of measuring the high frequency components of the TDI output, and maintaining the maximum point of the high frequency components by either changing the velocity of the image or by changing the charge transfer velocity within the camera. The high frequency components are those which are filtered with a high-pass filter.

In another aspect, the invention may comprise a system for synchronizing a time delay and integration (TDI) camera having a TDI output with high frequency components, comprising:
(a) means for measuring the high frequency components of the TDI output;
(b) means for comparing the measurement to a maximum measurement of the high frequency components to determine a velocity difference;
(c) means for altering the velocity of the image or the charge transfer velocity within the camera in response to a determination of a velocity difference.

The system may be implemented on a programmable logic device such as a field programmable gate array (FPGA) or other suitable processing system, such as a microcomputer, microprocessor or custom integrated circuit.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 (prior art) shows a schematic depiction of two image sensors scanning the object line by line and producing the same output.

FIG. 2 is a mathematical model of the TDI process.

FIG. 3 shows sampling pulses and functions for V not equal to V′.

FIG. 4 is a block diagram of the TDI process.

FIG. 5 is a graph of the frequency response of the moving average filter and the image spectrum represented by the rectangle inside the main lobe of the sinc function.

FIG. 6 shows the dependency of the average of the high frequency components of the TDI output with respect to V−V′.

FIG. 7 is a schematic architecture with difference operator and binary exponentiation functions.

FIG. 8 is a schematic architecture with 3 tap filter and absolute value functions.

FIG. 9A is a schematic architecture implementing an algorithm with adaptive velocity step size. FIG. 9B is a schematic architecture implementing an algorithm with multiple averaging periods.

FIG. 10 shows a graph depicting the response of the algorithm shown in FIG. 7 to step changes in image velocity.

FIG. 11 shows a graph depicting the response of the algorithm shown in FIG. 8 to step changes in the image velocity.

FIG. 12 shows a graph depicting the response of the algorithm shown in FIG. 9 to the step changes in the image velocity.

FIG. 13 shows the response of the algorithm shown in FIG. 15 with multiple averaging periods to step changes in the speed of an image with short periods (thin stripes).

FIG. 14 shows the response of the algorithm shown in FIG. 15 with multiple averaging periods to step changes in the speed of the picture with longer periods (thick stripes).

FIG. 15A shows an image with horizontal lines obtained by using a shaft encoder. FIG. 15B shows the same image obtained with the self-synchronization algorithm of FIG. 15.

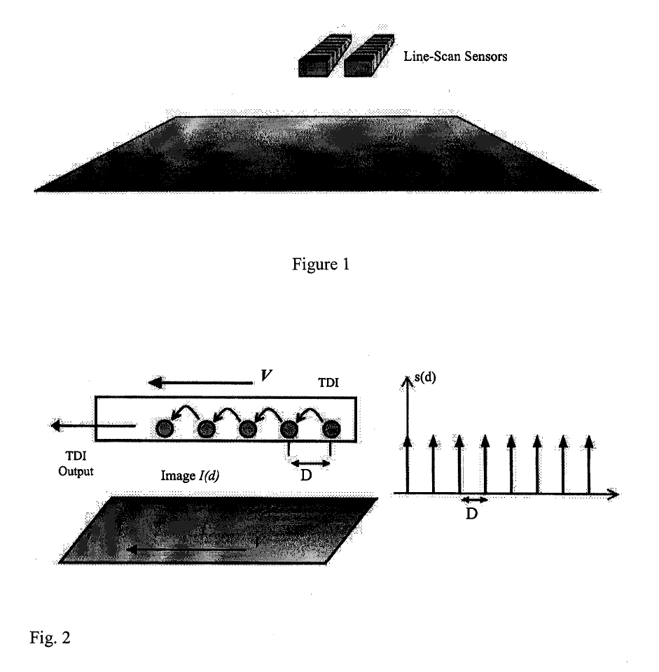

### DETAILED DESCRIPTION OF THE INVENTION

The present invention provides for methods and systems of synchronizing charge movement across a TDI image sensor with the actual velocity of the object being imaged, thereby synchronizing the output of a TDI camera. When describing the present invention, all terms not defined herein have their common art-recognized meanings.

The design of the algorithms of the present invention is based on a mathematical description of the TDI process. The TDI process may be modeled by treating it as a discrete time sampler. In one embodiment, it will be assumed that abrupt and large changes in the image speed will not be tracked, in order to simplify the process. In other words, the TDI speed and image speed are assumed to be close to each other at all times. With this assumption, the approximate mathematical model described herein is substantially accurate.

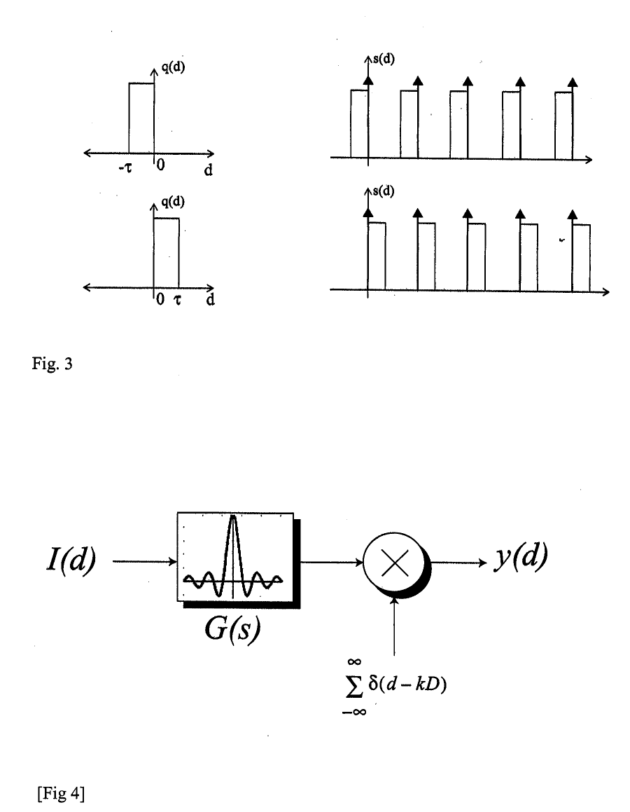

Another assumption which may be made in one embodiment is to ignore the vertical changes in output image dimension when the charge transfer and image velocities are not equal. As shown in FIG. 3, the distance between cells is D, the charge transfer velocity is V and the speed of the image is V′. The image signal is I(d). When V equals V′, we assume that the TDI process produces ideal sampling as shown in FIG. 2. The sampling function s(d) is as follows:

$$s ( d ) = {\sum }_{k = - ∞}^{∞} δ ( d - kD ) \qquad ( 1 )$$

where δ is the Dirac delta function in the limit as t approaches 0. This can be seen in the general expression given by Eqn. (2)

$$τ = L \frac{\vert {V}^{′} - V \vert}{V} \qquad ( 2 )$$

where L=Dn is the length of the TDI sensor, and n is the number of cells in one row. With t having a value greater than 0, the sampling function becomes rectangular rather than a perfect impulse. The new sampling function becomes:

$$s ( d ) = {\sum }_{k = - ∞}^{∞} \overline{q} ( d - kD ) \qquad ( 3 )$$

In this case, q is an averaging sampling pulse which is convolved with I(d), as shown here:

$$q ( d ) = \{ \begin{matrix}\frac{1}{τ} {\int }_{d - τ}^{d} I ( t ) ⅆ t & V > {V}^{′} \\ \frac{1}{τ} {\int }_{d}^{d + τ} I ( t ) ⅆ t & V < {V}^{′}\end{matrix} \qquad ( 4 )$$

When V does not equal V′, depending on which one is greater, two different cur. The sampling pulse q(d) and the sampling function s(d) are shown in FIG. 3, for these situations.

Without loss of generalization we will only consider the case for V>Vⁱ in Equation 4. The output of the TDI sensor is the convolution of I(d)with the sampling pulse q and is given by Equation 5.

$$y ( d ) = \frac{1}{τ} {\sum }_{k = - ∞}^{∞} [ δ ( d - kD ) \cdot {\int }_{kD - τ}^{kD} I ( t ) ⅆ t ] \qquad ( 5 )$$

Equation 6 is derived from Equation 5:

$$y ( d ) = \frac{1}{τ} ( {\int }_{- ∞}^{∞} I ( t ) q ( d - t ) ⅆ t ) \times {\sum }_{k = - ∞}^{∞} δ ( d - kD ) \qquad ( 6 )$$

One embodiment of the block diagram of the system is shown in FIG. 4. The system corresponds to a moving-average low-pass filter whose cut-off frequency (or length) changes with t.

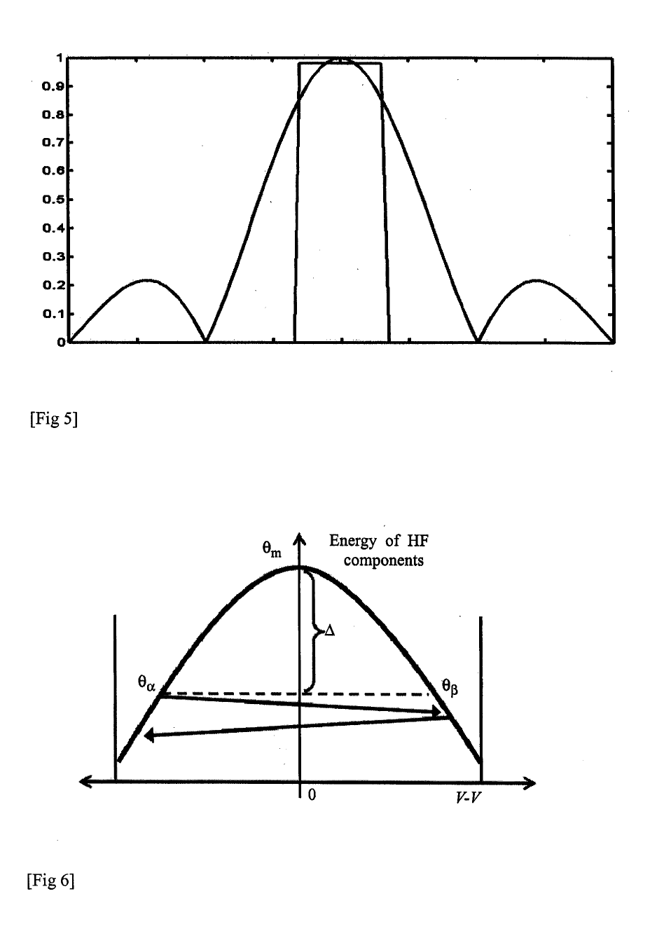

When T→0, then G(s)→1 and therefore has no effect on the image signal I(d). When t differs from zero, G(s) converges to a moving average filter corresponding to a sinc function in the frequency domain. In this case, the frequency domain representation of G(s) converges to a sinc function with a wide main lobe, as shown in FIG. 5. This monotonically reduces the high frequency components of I(d).

Therefore, as t increases, the bandwidth of the low-pass filter, G(s), decreases. If the average of the energy of the high frequency components of the output of the TDI with respect to t is calculated, a curve similar to that shown in FIG. 6 is obtained. The type of the curve that can be obtained depends on the magnitude of the high frequency (HF) components in the image, I(d). If the image does not have many high frequency signal components, then the curve obtained will be relatively flat. One solution to maintaining image velocity the same as charge transfer velocity is a control system which tries to maintain the maximum point of the HF average curve by changing the speed V, or equivalently by changing the clock frequency of the TDI system.

Extremum-seeking systems are discussed in Nusawardhana, S. H. Zak; “Extremum Seeking Using Analog Nonderivative Optimizers” American Control Conference 2003 Denver, Colo. p 3242-3247, for analog systems and in Hai Yu, U. Ozguner; “Smooth Extremum Seeking Control via Second Order Sliding Mode” American Control Conference 2003 Denver, Colo. p 3248-3253. for discrete systems. These references are incorporated herein by reference. To seek the maximum point of this curve, first of all the system must measure the HF components of the TDI output. The control system is non-linear since the output is only dependent upon the absolute velocity difference |V−V′|.

In one embodiment, the HF components of the TDI output comprise the output of a filter such as a high-pass filter applied to the TDI image signal. Although the filter may output a wide frequency range, it may be seen by those skilled in the art that the higher frequency components will be more salient than the lower frequency components in the method of the present invention. In one embodiment, the HF components substantially comprise components in the higher ⅔ portion of the range, where most significant changes occur due to the TDI process, with the lower ⅓ portion contributing significantly less to the method.

Where the high-frequency components of the TDI output are measured with a high-pass filter, the frequency response of this filter should preferably monotonically increase with a shallow gradient since the frequency properties of the image signal are unknown. Preferably, the filter should also compensate for the loss of high frequency components, as shown in FIG. 5. A filter with a frequency response of the form of a ramp function is preferred for this purpose. The following low order filters may be suitable:
1. Difference operator:
   y[n]=x[n]−x[n−1] (7)
2. Three tap high pass filter:
   y[n]=−x[n]+2x[n−1]−x[n−2] (8)
   These filters may be preferred because they can be implemented without using general multiplication circuitry.

In order to obtain a measure of the energy of the high frequency components of the TDI output signal, the output of these filters should be squared and averaged. If a squaring function requires excessive FPGA resources, alternative functions may be used instead. The alternative functions may include the absolute value function or the binary exponentiation of the absolute value function:
f(x)=2^{|x|} (9)

This function can be realized by a simple bit shift function. The problem of the large dynamic range associated with Eqn. 9, can be overcome by holding this number in a 16-bit floating point number format where the most significant byte holds the mantissa and the least significant byte holds the exponent. Rather than compare the average of the absolute values, over the number of samples, the sums are compared. As a result, the need for division by m is eliminated. The absolute value function does not work with the difference operator because of the linearity of the absolute value function at values other than zero. The difference operator and the sum function cancel each other out.

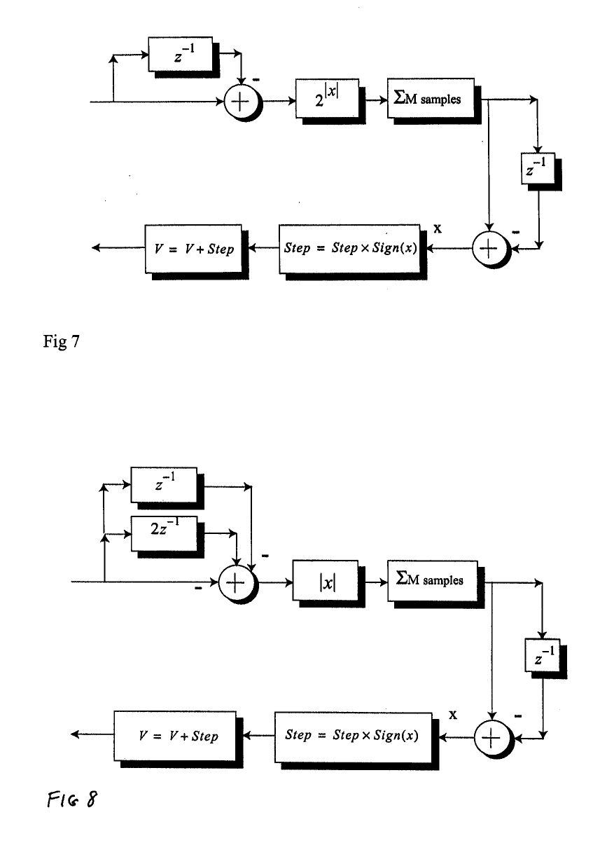

The present invention may comprise two alternative embodiments having different extremum seeking architectures: the first embodiment uses a difference operator plus binary exponentiation; the second embodiment uses a 3-tap filter and absolute value function. These architectures are respectively shown in FIG. 7 and FIG. 8. No general multiplication circuitry is required in either case.

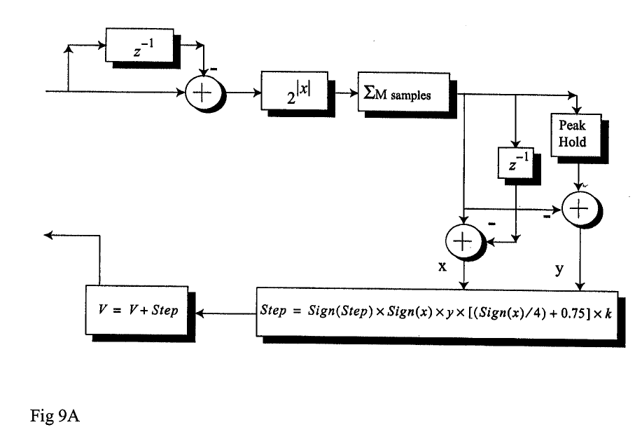

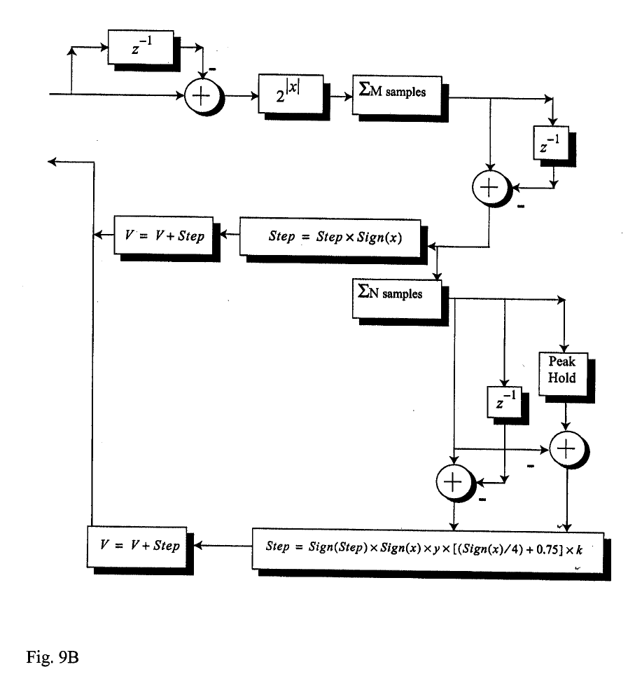

In both architectures, a fixed step size is used to change the rate of the TDI clock. In an alternative embodiment, an adaptive step size may be used, which may result in a better response. The maximum value of the curve shown in FIG. 6 may be used to obtain an adaptive step size. The difference between the value of the system that is currently on the curve and the maximum value of this curve is used as a measure for the adaptive step size. The architecture for an adaptive step size extremum seeking system is shown in FIG. 9A.

Because the algorithms shown in FIG. 7 and FIG. 8 use a constant step size, as long as the step size is not very large, stability is not a concern for these algorithms. These algorithms will climb to the top of the curve shown in FIG. 6 and fluctuate around the maximum point of the curve. While the step size increases the speed of convergence, it also increases the distance of these fluctuations away from the maximum point of the curve. As a result, there is a compromise between the convergence speed and fluctuation distance. If the step size is kept too high then there is a possibility that the algorithm might jump to side lobes of the sinc function, shown in FIG. 5, and seek the maximum of that side lobe. On the other hand the algorithm shown in FIG. 9A requires more detailed analysis because of the adaptive step size.

From the mathematical model we know that the curve shown in FIG. 6 is an even function. This curve may be approximated with a parabola:
F(θ)=−aθ²+b² (10)
where θ=V−V′.

If the maximum point of the curve be at θm=0 and the value of parabola is Fm=F(θm)=F(0), then the step value, S, for any arbitrary point θm is calculated as:
S=Δ·k (11)
where k is an arbitrary constant. Fm is stored in the Peak Hold circuitry. Then, the point θa, where:
θ_{α}+k·Δ=θ_{β} (12)
is the boundary of the stable region. Any point less than θa or greater than θb is unstable. If the algorithm reaches a point less than θa, as shown in FIG. 6, additional jumps will cause the system to increase the step size, causing the system to become unstable. Therefore, as k increases, the region of stability decreases. Because the speed of convergence is directly proportional to k, the value selected for k is a compromise between response speed and stability. A suitable compromise to extending the stable region is to reduce k by 50% (a simple right shift in FPGA hardware) whenever the climbing direction changes. This ensures that whenever the value of θ drops close to θa, the next value of θ will be considerably less than θb putting the system back to stable region. Thus the step value becomes:

$$S = \{ \begin{matrix}Sign ( {S}^{*} ) \times k \cdot Δ & x > 0 \\ - Sign ( {S}^{*} ) \times k \cdot Δ \times \frac{1}{2} & x < 0\end{matrix} \qquad ( 13 )$$

where x is the value shown in FIG. 9A and S* is the previous value of S. The ½ factor also acts as the damping factor of the system when the top point of the curve is reached.

When the image contains very little high frequency information, or if the image has a definite texture with a very long period, the averaging period, m, should preferably be very large. However, as m increases, response time also increases. Therefore, increasing the averaging period of the algorithm decreases the efficiency, especially when the image is a random texture such as cork, sandpaper or fabric, as these types of textures require very short periods and are much more affected by synchronization errors.

In a preferred embodiment, multiple averaging periods may be used. While the first stage of the algorithm takes averages of high frequency components for small periods, a second stage can take the average of the difference of averages calculated by the first step and make independent decisions on whether to increase or decrease the TDI speed. By keeping the speed change steps of the first stage smaller than the second stage, the resulting algorithm can be used for textures with both short and long periods. This algorithm has a very short response time and may still be applicable to images that have short or long periods. This is especially useful when the image has a long period with background noise. The architecture that implements this algorithm with multiple averaging periods is shown in FIG. 9B.

Those skilled in the art will appreciate that algorithms within the scope of the present invention may combine both an adaptive step size and multiple averaging periods.

The algorithms of the present invention may be implemented in well-known programmable logic devices such as standard field-programmable gate arrays (FPGAs) which are well known in the art. In order to generate clock pulses to drive the TDI sensor, a programmable clock divider may also be implemented in the FPGA. This clock divider divides a 20MHz clock to obtain clock pulses in the range of 1-10KHz. The algorithm shown here modifies the division factor of the clock divider instead of the frequency of the clock in order to avoid division circuitry, but the use of a general divider, or similar means, is also included in the Scope of the Invention.

### EXAMPLES

The following examples are intended only to exemplify embodiments of the present invention, not to limit the invention claimed herein.

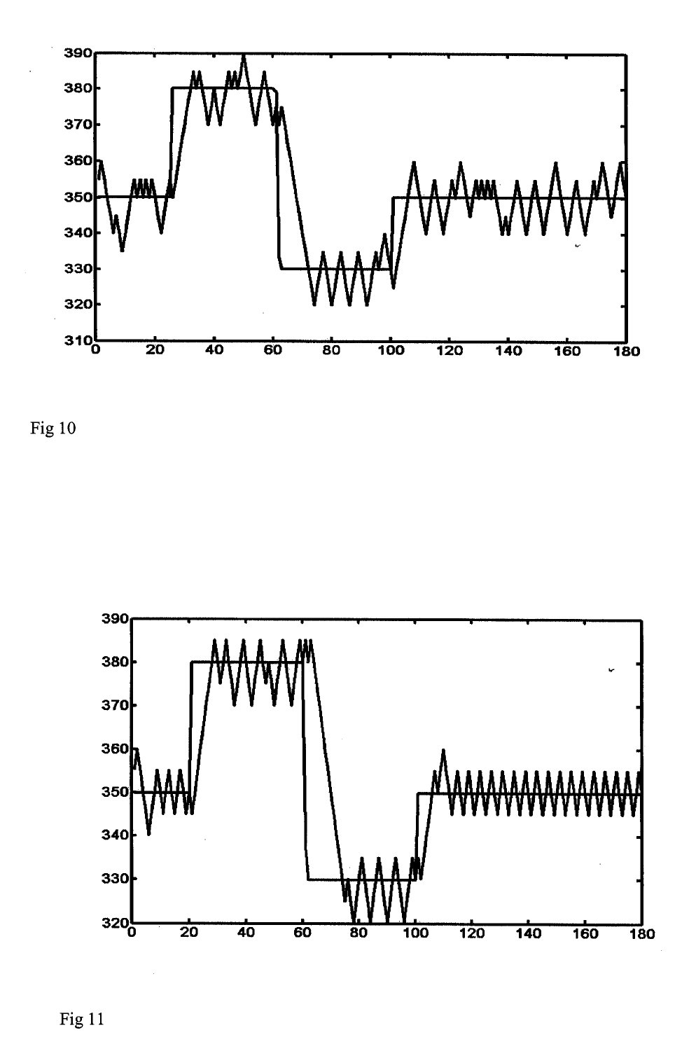

The algorithms of the present invention were tested using a Matlab™ simulator. Results from this simulation for the architecture shown in FIG. 7 is given in FIG. 10. Although the original design specifications of the control system did not require it to match sudden changes in the image speed, the simulation results show that the algorithm can match almost a 20% step change in the image speed. FIG. 11 shows the response of the system with the 3-tap filter and absolute value function from FIG. 8.

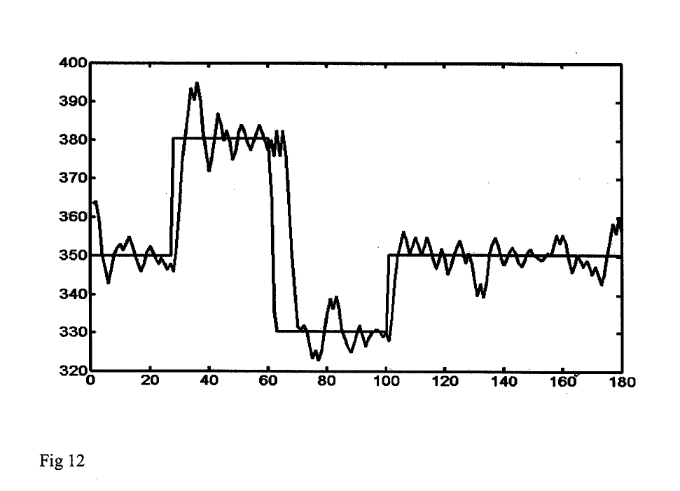

It was found that the system shown in FIG. 8 does not converge as fast as the one shown in FIG. 7 and it is also less stable. However, the system shown in FIG. 8 does have the advantage of lower processing complexity. FIG. 12 shows the response of the system with an adaptive step size from FIG. 9A. As may be seen, this system matches the TDI speed changes very quickly and is more stable than the other architectures.

96 TDI stages were used during the simulations to emulate the number of stages used in many commercial TDI sensors. These architectures also prove effective for fewer stages. There are large fluctuations in FIG. 11 around the edges when a step change occurs in image speed; these are due to the adaptive step size. There is also a peak over-shoot after a sudden speed change before the system settles.

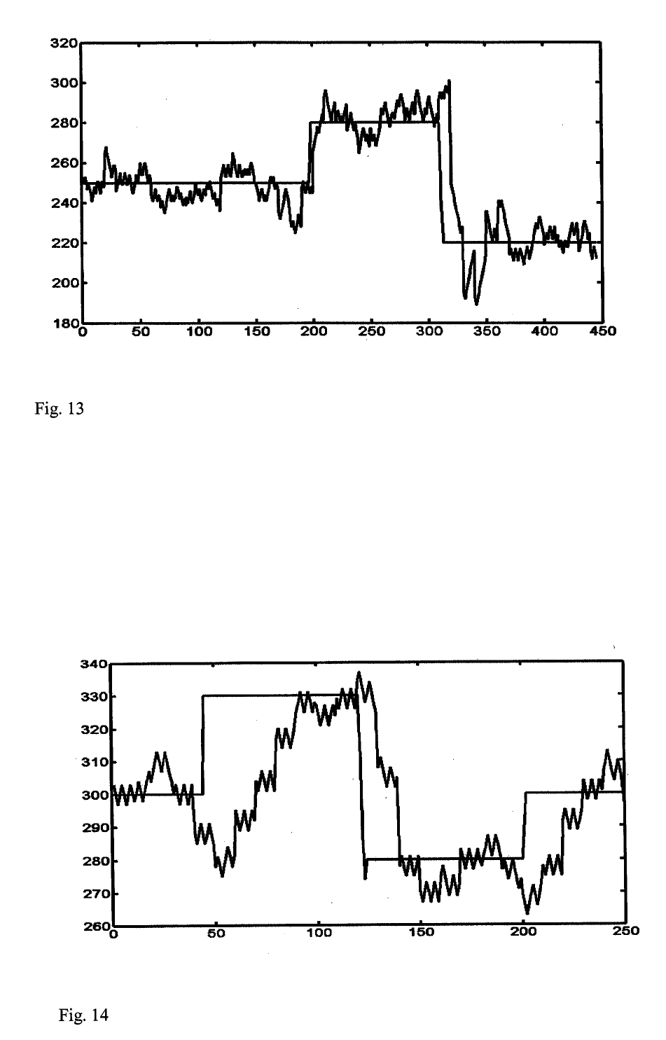

FIG. 13 shows the response of the algorithm shown in FIG. 9B to step changes in the speed of an image with short periods, in this case thin stripes. FIG. 14 is the response of the same algorithm for an image with a longer period (thick stripes). As shown in FIG. 14, the second stage changes the speed in larger steps. That is because it averages longer periods and in case of any decision conflicts between the second and first stage, the second stage dominates. FIG. 14 shows that the algorithm has a very slow response when the image with thick stripes is used and it is not as stable as the previous algorithms even for the thin striped image. On the other hand, this algorithm has a sufficiently low response time to maintain adequate synchronization with both types of images.

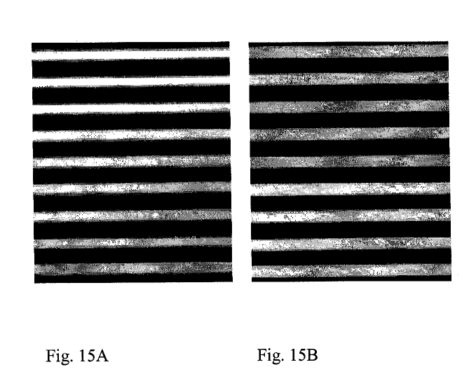

A fabric texture and a texture with horizontal lines were used to test the algorithm. The algorithm successfully tracks the image speed when it is changed gradually. FIG. 15A shows images obtained with a shaft encoder and FIG. 15B with the self-synchronization algorithm. When the algorithm matches the image speed, the image is even sharper than that obtained using the shaft encoder. A drum with a shaft encoder was used to emulate a commercial conveyor system. The drum exhibited some mechanical flutter in rotation speed that produced the problems with the shaft encoder. The superior quality of the self synchronization algorithm under these conditions is evident. The response of the adaptive step size algorithm is predicted to be even more stable.

As will be apparent to those skilled in the art, various modifications, adaptations and variations of the foregoing specific disclosure can be made without departing from the scope of the invention claimed herein.

1. A method of synchronizing a time delay and integration (TDI) camera having a TDI output, comprising the steps of measuring components of a high frequency portion of the TDI output and maintaining the maximum point of the high frequency components by either changing the velocity of the image or by changing the charge transfer velocity within the camera.

2. The method of claim 1 wherein the high frequency components of the TDI output are measured by filtering the TDI output with a high-pass filter and applying a squaring function to the filter output.

3. The method of claim 2 wherein the high-pass filter comprises either a difference operator or a three tap high pass filter.

4. The method of claim 2 wherein the squaring function comprises an absolute value function or a binary exponentiation of an absolute value function.

5. The method of claim 4 wherein the high pass filter comprises a difference operator and the squaring function comprises a binary exponentiation.

6. The method of claim 4 wherein the high pass filter comprises a three-tap filter and the squaring function comprises an absolute value function.

7. The method of claim 3 wherein the binary exponentiation of an absolute value function is realized with a simple bit shift function using a 16 bit floating point number format.

8. The method of claim 1 wherein the velocity change is implemented with a fixed step size.

9. The method of claim 1 wherein the velocity change is implemented with an adaptive step size.

10. The method of claim 9 wherein the adaptive step size is substantially equal to the difference between the measure of the high frequency components in a current sample and a maximum measure of the high frequency components.

11. The method of claim 1 wherein the high frequency components are measured over a plurality of samples in an averaging period.

12. The method of claim 11 further comprising the step of using multiple averaging periods.

13. The method of claim 1 wherein the high frequency components have a frequency in the higher ⅔ portion of the frequency range of the TDI output.

14. A system for synchronizing a time delay and integration (TDI) camera having a TDI output with high frequency components, comprising:
(a) means for measuring the high frequency components of the TDI output over a number of samples;
(b) means for comparing the measurement to a maximum point of the high frequency components to determine a velocity difference;
(c) means for altering the velocity of the image or the charge transfer velocity within the camera in response to a determination of a velocity difference.

15. The system of claim 14 comprising circuits implemented on a programmable logic device.

16. The system of claim 13 wherein the programmable logic device is a field programmable gate array.
